(19) United States
(12) Patent Application Publication
(10) Pub. No.: US 2003/0123801 A1
(43) Pub. Date: Jul. 3, 2003

(54) All-fiber dynamic optical wavelength switch/filter device

(76) Inventor: David R. Rolston, Pierrefonds (CA)

Correspondence Address: PERMAN & GREEN, 425 POST ROAD, FAIRFIELD, CT, 06824, US

(21) Appl. No.: 10/301,309

(22) Filed: Nov. 21, 2002

(30) Foreign Application Priority Data
Nov. 27, 2001 (CA) 2,363,806

(51) Int. Cl. G02B 6/26

(52) U.S. Cl. 385/43

(57) ABSTRACT

The optical wavelength switch/filter device controls propagation of an optical signal through first and second optical fibers. A biconical taper is formed of fused and stretched portions of the first and second optical fibers, and Erbium atoms dope at least the biconical taper of the first and second optical fibers. The first optical fiber defines, on a first side of the biconical taper, a first optical signal input supplied with the optical signal. The first and second optical fibers define, on a second side of the biconical taper opposite to the first side, first and second outputs, respectively. The second optical fiber defines, on the first side, a second pump light beam input supplied with a 980-nm pump light beam in order to control a propagation characteristic of the optical signal from the first input to the first and second outputs through the biconical taper. An additional biconical taper can be formed on the optical fibers to define a Mach-Zehnder fiber interferometer structure.

### BACKGROUND OF THE INVENTION

1. Field of the Invention

The present invention relates to a method of controlling propagation of an optical signal through first and second optical fibers and an optical wavelength switch/filter device for conducting this method.

2. Brief Description of the Current Technology

U.S. Pat. No. 4,834,481 (Lawson et al.) issued on May 30, 1989 describes a single-mode fiber optic multiplexer/demultiplexer. In this multiplexer/demultiplexer, a first single-mode optical fiber is used to propagate first and second signals of different wavelengths in opposite directions. At one end of the first optical fiber, a second single-mode optical fiber is placed in juxtaposition with the first optical fiber and their claddings are fused together to form a first fiber optic coupler. At the other end of the first optical fiber, a third single-mode optical fiber is placed in juxtaposition with the first optical fiber and their claddings are fused together to form a second fiber optic coupler. The first coupler propagates the first signal through the first optical fiber toward the second coupler, but transfers the second signal received from the second coupler from the first to the second optical fiber. The second coupler propagates the first signal from the first coupler through the first optical fiber, but transfers the second signal from the third optical fiber to the first optical fiber for propagation toward the first coupler.

U.S. Pat. No. 6,226,091 B1 granted to Cryan on May 1, 2001 discloses an asymmetic Mach-Zehnder interferometer structure formed of two laterally adjacent optical fibers. The Mach-Zehnder interferometer structure comprises two concatenated couplers separated by sections of the two optical fibers. This Mach-Zehnder interferometer structure also comprises Bragg gratings in the sections of optical fibers between the two couplers.

U.S. Pat. No. 5,027,079 granted to Desurvire et al. on Jun. 25, 1991 describes an Erbium-doped fiber amplifier. Parameters which determine the operating characteristics of an Erbium-doped fiber amplifier are the concentration of Erbium in the core of a fiber, the ratio of the radius of the core of the fiber doped with Erbium relative to the radius of the core of the fiber, and the length of the fiber. This patent indicates that improved fiber amplifier performance can be obtained by varying the core-cladding refractive index difference of the fiber.

### SUMMARY OF THE INVENTION

In accordance with the present invention there is provided a method for controlling propagation of an optical signal through first and second optical fibers wherein the first optical fiber defines a first input and a first output, and the second optical fiber defines a second input and a second output. This method comprises forming a biconical taper by fusing portions of the first and second optical fibers together and, then, stretching these fused optical fiber portions, doping the first and second optical fibers with atoms at least in the biconical taper, injecting the optical signal in the first input, and injecting a pump light beam in the second input in order to control a propagation characteristic of the optical signal from the first input to the first and second ouputs through the biconical taper.

Preferably, the pump light beam injection comprises:

selecting a wavelength of the pump light beam suitable for transferring energy from the pump light beam to the doping atoms; and

adjusting an intensity of the pump light beam for controlling the propagation characteristic of the optical signal from the first input to the first and second ouputs through the biconical taper.

The energy transferred from the pump light beam to the doping atoms changes the index of refraction and, simultaneously, the filtering characteristic of the biconical taper.

When the doping atoms are Erbium atoms, the pump light beam is a 980-nm light beam.

In the present specification and the appended claims, the term “atoms” is also intended to cover molecules. Of course, it is within the scope of the present invention to use suitable atoms other than Erbium to dope the optical fibers; an example is prasiodymium.

According to a preferred embodiment, the propagation controlling method comprises forming another biconical taper by fusing together portions of the first and second optical fibers and, then, stretching the fused optical fiber portions, concatenating the two biconical tapers between (a) the first and second inputs and (b) the first and second outputs, separating the two biconical tapers by sections of the first and second optical fibers to form a Mach-Zehnder fiber interferometer structure, and doping with the atoms the two biconical tapers and the sections of first and second optical fibers separating the two biconical tapers.

Advantageously, the optical signal comprises a plurality of multiplexed optical signals of different wavelengths, and the propagation controlling method comprises adjusting the intensity of the pump light beam so as to propagate each optical signal toward a respective one of the first and second outputs.

The present invention also relates to an optical wavelength switch/filter device for controlling propagation of an optical signal, comprising first and second optical fibers and a biconical taper. The biconical taper is formed of fused and stretched portions of the first and second optical fibers. Atoms dope at least the biconical taper of the first and second optical fibers. The first optical fiber defines, on a first side of the biconical taper, a first optical signal input for being supplied with the optical signal. The first and second optical fibers define, on a second side of the biconical taper opposite to the first side, first and second outputs, respectively. Finally, the second optical fiber defines, on the first side of the biconical taper, a second pump light beam input for being supplied with a pump light beam in order to control a propagation characteristic of the optical signal from the first input to the first and second ouputs through the biconical taper.

According to preferred embodiments of the optical wavelength switch/filter device:

the optical wavelength switch/filter device further comprises a source of pump light beam connected to the second input to inject in that second input the pump light beam having a frequency selected to transfer energy from the pump light beam to the doping atoms, and an intensity adjusted to obtain the desired propagation characteristic;

the source is a variable pump light beam source through which the intensity of the pump light beam is changed in order to modify the propagation characteristic of the optical signal from the first input to the first and second ouputs through the biconical taper;

the optical wavelength switch/filter device further comprises another biconical taper formed of fused and stretched portions of the first and second optical fibers, these two biconical tapers being concatenated between (a) the first and second inputs and (b) the first and second outputs, and those two biconical tapers being separated by sections of the first and second optical fibers to form a Mach-Zehnder fiber interferometer structure;

the two biconical tapers and the sections of first and second optical fibers separating the two biconical tapers are doped with the above mentioned atoms; and

the Mach-Zehnder fiber interferometer structure forms a comb-filter having a filtering characteristic dependent on the intensity of the pump light beam.

The foregoing and other objects, advantages and features of the present invention will become more apparent upon reading of the following non restrictive description of a preferred embodiment thereof, given by way of example only with reference to the accompanying drawings.

### BRIEF DESCRIPTION OF THE DRAWINGS

In the appended drawings:

FIG. 1 is a schematic illustration of an all-fiber dynamic optical wavelength switch/filter using an Erbium-doped Mach-Zehnder fiber interferometer structure;

FIG. 2 is a schematic illustration of the phenomenon produced by energizing doping Erbium atoms by the 980-nm pump light beam;

FIGS. 3a and 3b are graphs showing shifting of the wavelength characteristic of the comb-filter formed by the Erbium-doped Mach-Zehnder fiber interferometer stucture of FIG. 1 when supplied with pump light beams of different intensities;

FIG. 4a is a schematic illustration of the propagation of an optical signal of wavelenght λ₁ through a biconical optical fiber taper; and

FIG. 4b is a schematic illustration of the propagation of an optical signal of wavelenght λ₂ through a biconical optical fiber taper.

### DETAILED DESCRIPTION OF THE PREFERRED EMBODIMENTS

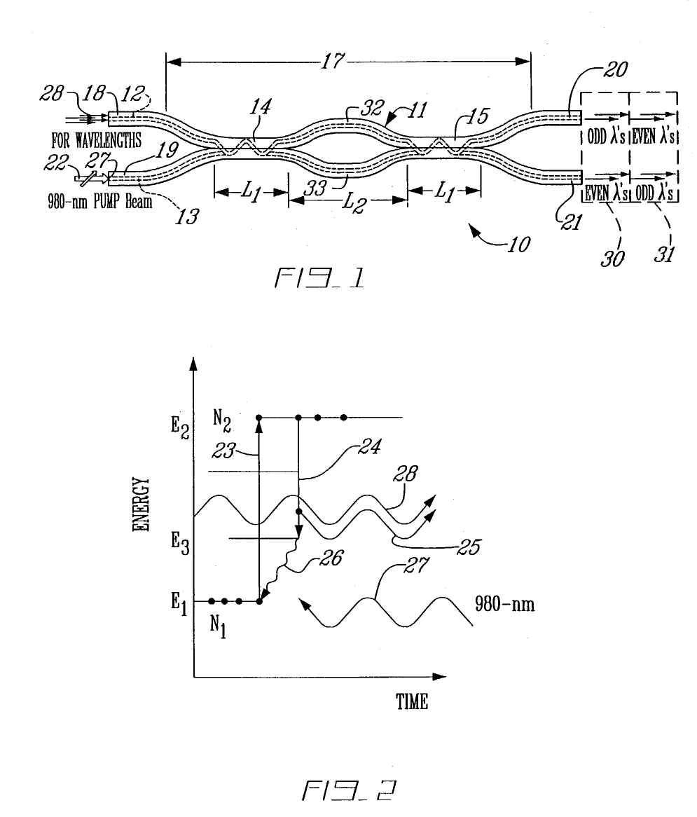

FIG. 1 illustrates a preferred embodiment of the all-fiber dynamic optical wavelength switch/filter device, generally identified by the reference 10.

As illustrated in FIG. 1, the switch/filter device 10 comprises an Erbium-doped Mach-Zehnder fiber interferometer structure 11.

The Mach-Zehnder interferometer structure 11 of FIG. 1 is made of two identical, stripped optical fibers 12 and 13. This does not exclude the use of two different optical fibers 12 and 13 to carry out the present invention.

The stripped optical fibers 12 and 13 are doped with Erbium atoms in a concentration of less than 1%, within the limits indicated by the arrows 17. It should also be pointed out that at least the biconical tapers 14 and 15 must be doped. As indicated hereinabove:

in the present specification and the appended claims, the term “atoms” is also intended to cover molecules; and

atoms other than Erbium could eventually be used for doping the optical fibers 12 and 13; an example is prosiodymium.

Suitable methods for doping the fibers 12 and 13 are believed to be within the knowledge of those of ordinary skill in the art and, accordingly, will not be further described in the present specification.

The optical fibers 12 and 13 co-extend with each other and are fused together to form a first biconical taper 14 and a second biconical taper 15. The biconical tapers 14 and 15 are concatenated but longitudinally spaced apart from each other by sections 32 and 33 of the optical fibers 12 and 13. The first and second biconical tapers 14 and 15 have a typical length L₁ of 1.5-2.5 cm while the separation length L₂ (length of optical fiber sections 32 and 33) is situated within the range of 2.5-3.5 cm.

Although this is not specifically illustrated in the appended drawings, it will be seen from the following description that the concept of the present invention operates with one biconical taper such as 14 only.

An optical fiber consists of a central core surrounded by a cladding itself enveloped by a polymer coating. In the region of the biconical tapers 14 and 15 and the optical fiber sections 32 and 33, the polymer coating of the two optical fibers 12 and 13 is stripped off using acetone or other solvents, or even by mechanical means. As well known to those of ordinary skill in the art, the fused biconical taper 14 is made by placing portions of the stripped optical fibers 12 and 13 in contact with each other, then heating them using a flame or any other suitable means until the glass of the fibers has melted into one another, and finally stretching the melted fiber portions. In the same manner, the fused biconical taper 15 is made by placing corresponding portions of the stripped optical fibers 12 and 13 in contact with each other, then heating them using a flame or any other suitable means until the glass of the fibers has melted into one another, and finally stretching the melted fiber portions. In most instances, laser power at a certain wavelength is injected into one fiber, and the power levels in each of the output branches are monitored as the fiber portions are fused and tapered. The flame is controlled and the fiber sections are stretched until the desired coupling ratio is obtained. Fabrication of fused biconical tapers is otherwise well known to those of ordinary skill in the art and, accordingly will not be further described in the present specification.

The first optical fiber 12 defines a first input 18 and a first output 20 of the Erbium-doped Mach-Zehnder interferometer structure 11. In the same manner, the second optical fiber 13 defines a second input 19 and a second output 21 of the Erbium-doped Mach-Zehnder interferometer structure 11. Referring to FIG. 1, the inputs 18 and 19 and the outputs 20 and 21 are located on opposite sides of the set of biconical tapers 14 and 15.

An incident optical signal formed, for example, of multiplexed optical signals of different wavelengths is supplied to the first input 18. A variable pump light beam source 22 is connected to the input 19 to inject in that input 19 a pump light beam 27 at a wavelenght of 980 nm. A pump light beam having a wavelength of 980 nm is selected because its energy will be absorbed by the doping Erbium atoms. By modifying the intensity of the 980 nm-wavelength pump light beam pumped through the input 19, it is possible to control the propagation characteristic of the incident optical signal 28 from the first input 18 toward the first 20 and second 21 outputs through the biconical tapers 14 and 15.

Operation of the all-fiber dynamic optical wavelength switch/filter device will now be described.

Single-mode Optical Fibers

In the preferred embodiment of the present invention, the optical fibers 12 and 13 are single-mode optical fibers.

As well known to those of ordinary skill in the art, single-mode optical fibers use a very small core, usually around 8 microns in diameter, where the light is guided by the rapid low-high-low step index change of the cladding-core-cladding region. Because of the small size of the low-high-low index of refraction change in single-mode optical fibers, only one propagation direction is allowed in the core for wavelengths greater than the “cut off” wavelength. However, since light always diffract, light also exists outside the core in the cladding; this is called the evanescent wave and results in an effective mode-field diameter.

When a single-mode fiber taper 14 is made as described hereinabove, the core regions of the two fibers never touch each other. As the cores become smaller and closer together, the amount of light energy in the evanescent wave increases although the overall energy remains constant. As the cores are forced closer together, the energy of the evanescent wave “feels” the guiding path of the “empty” core and begins to transfer the energy from the primary path (fiber 12) into the secondary path (fiber 13). This also creates two “modes” of light propagation, one in the core and one outside the core. This process continues until all the energy is switched to the other path, whereupon the whole procedure starts over again drawing the energy out of the secondary path and back into the primary path. The oscillation (see 40 in FIGS. 4a and 4b) is actually produced by a small difference in the speed of the two modes travelling in the core and cladding, and which are called the group velocities. This separation of energy, from the same light, causes an interference pattern and gives rise to the energy transfer along the biconical taper. The amount of coupling at the output (see 41 in FIGS. 4a and 4b) is dependent on the length of light travel, as the energy reaches the split (see 42 in FIGS. 4a and 4b) of the two fibers, to give a certain percentage of light to either arm 43 and 44 depending on where in the oscillation period it ended up. By using the above production procedure, the biconical taper 14 can be tuned to any desired coupling ratio. And this coupling process is both wavelength and taper-length dependent.

As indicated in the foregoing description, the single-mode optical fibers forming the taper are doped with Erbium atoms. Referring to FIG. 2, Erbium atoms N₁ will absorb energy from the 980-nm pump light beam 27 to move from a lower energy level E₁ to a higher energy level E₂ (see arrow 23). Erbium atoms N₂ at energy level E₂ will release energy (see arrow 24) to produce photons such as 25 at the same wavelength as the propagated optical signal 28 injected through the other input 18. The latter Erbium atoms N₂ will then pass to a lower energy level E₃ to subsequently return to level E₁ (see arrow 26). Regarding the photons 25, they will add to the propagated optical signal 28. This phenomenon will obviously change the index of refraction within the doped optical fiber taper 14.

Therefore, by optically pumping a 980-nm light beam in the Erbium-doped region, the index of refraction changes in the biconical taper 14 to thereby change the ratio of coupling from one fiber to the other within the fused taper 14. The index of refraction of the Erbium-doped taper 14 changes as a function of the power (intensity) of the 980-nm pump light beam injected in the second input 19 by source 22 to thereby enable dynamic modification of the filter/switch device propagation characteristic accompanied by a dynamic change of the output light on the first 20 and second 21 outputs. This dynamic modification or change is conducted through appropriate control of the 980-nm pump light beam source 22 (FIG. 1).

Mach-Zehnder Interferometer Structure

Although the concept of the present invention operates, as described hereinabove, with one biconical taper such as 14 only, the switch/filter device 10 can be made more adaptive and versatile by using a Mach Zehnder fiber interferometer structure 11 as illustrated in FIG. 1.

The Mach-Zehnder interferometer structure 11 is obtained by fusing a second biconical taper 15 on the two optical fibers 12 and 13 in close proximity to the first taper 14, using the same procedure as explained in the foregoing description. The basic idea is that the filtering capabilities of the two biconical tapers 14 and 15 combined with a path difference in the two sections 32 and 33 of the optical fibers 12 and 13 both act simultaneously, but in opposite directions. When the biconical tapers 14 and 15 are acting to transfer the optical signal from the primary path (fiber 12) to the secondary path (fiber 13), the interferometer structure is acting to interfere such that the optical signal should be moving from the secondary path back to the primary path.

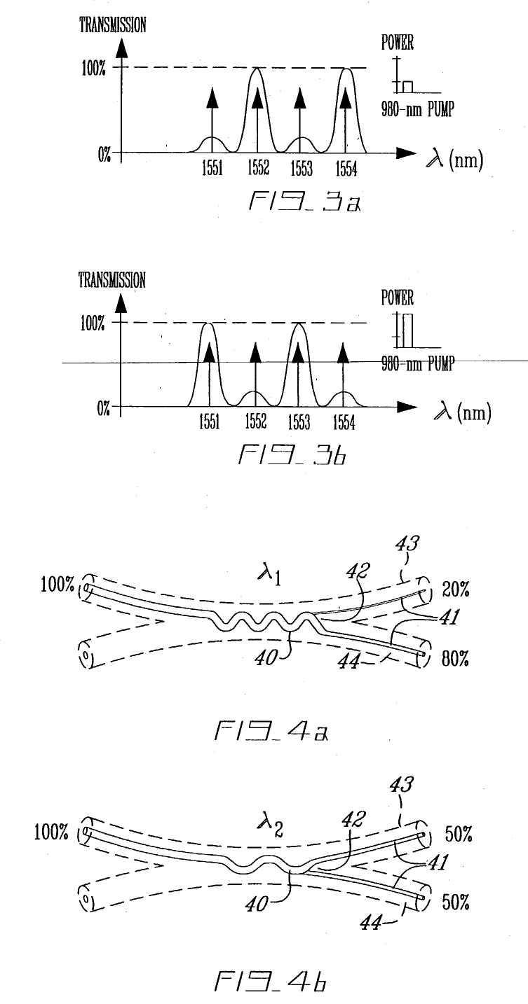

In the preferred embodiment of the Erbium-doped Mach-Zehnder fiber interferometer structure 11 of FIG. 1, a comb-filter operation for optical wavelenght λ is obtained. The resulting comb-filter can be shifted simply by changing the power (intensity) of the 980-nm pump light beam 27 supplied to the second input 19. An example of such wavelength shift is illustrated in FIGS. 3a and 3b. FIG. 3a corresponds to a lower power 980-nm pump light beam 22 while FIG. 3b corresponds to a higher power 980-nm pump beam 22.

Referring to FIG. 1, the optical signal is formed of four multiplexed optical signals of different wavelengths. Source 22 can be controlled to adjust the intensity of the pump light beam 27 so as to the propagation characteristic to propagate each optical signal toward a respective one of the first 20 and second 21 outputs. For example, the “odd” wavelenghts (1551 and 1553 nm) can be directed toward output 20 while the “even” wavelengths (1552 and 1554 nm) will be directed toward output 21 (see example 30 in FIG. 1). In the alternative (see example 31 in FIG. 1), the “even” wavelenghts (1552 and 1554 nm) can be directed toward output 20 while the “odd” wavelengths (1551 and 1553 nm) will be directed toward output 21.

Although the present invention has been described hereinabove by way of a preferred embodiment thereof, this embodiment can be modified at will, within the scope of the appended claims, without departing from the spirit and nature of the subject invention.

What is claimed is:

1. An optical wavelength switch/filter device for controlling propagation of an optical signal, comprising:
first and second optical fibers;
a biconical taper formed of fused and stretched portions of the first and second optical fibers; and
doping atoms in at least the biconical taper of the first and second optical fibers; wherein:
said first optical fiber defines, on a first side of the biconical taper, a first optical signal input for being supplied with the optical signal;
said first and second optical fibers define, on a second side of the biconical taper opposite to said first side, first and second outputs, respectively; and
the second optical fiber defines, on said first side of the biconical taper, a second pump light beam input for being supplied with a pump light beam in order to control a propagation characteristic of the optical signal from the first input to the first and second ouputs through the biconical taper.

2. The optical wavelength switch/filter device of claim 1, further comprising a source of pump light beam connected to the second input to inject in said second input said pump light beam having:
a frequency selected to transfer energy from the pump light beam to the doping atoms; and
an intensity adjusted to obtain said propagation characteristic.

3. The optical wavelength switch/filter device of claim 2, wherein said source is a variable pump light beam source through which the intensity of the pump light beam is changed in order to modify the propagation characteristic of the optical signal from the first input to the first and second ouputs through the biconical taper.

4. The optical wavelength switch/filter device of claim 2, wherein the doping atoms are Erbium atoms, and wherein the pump light beam is a 980-nm light beam.

5. The optical wavelength switch/filter device of claim 1, further comprising another biconical taper formed of fused and stretched portions of the first and second optical fibers, the two biconical tapers being concatenated between (a) said first and second inputs and (b) said first and second outputs, and said two biconical tapers being separated by sections of said first and second optical fibers to form a Mach-Zehnder fiber interferometer structure.

6. The optical wavelength switch/filter device of claim 5, wherein the two biconical tapers and said sections of first and second optical fibers separating the two biconical tapers are doped with said atoms.

7. The optical wavelength switch/filter device of claim 5, wherein the Mach-Zehnder fiber interferometer structure forms a comb-filter having a wavelength characteristic dependent on the intensity of the pump light beam.

8. The optical wavelength switch/filter device of claim 3, wherein said optical signal comprises a plurality of multiplexed optical signals of different wavelengths, and wherein said source comprises means for adjusting the intensity of the pump light beam so as to propagate each optical signal toward a respective one of said first and second outputs.

9. A method for controlling propagation of an optical signal through first and second optical fibers, the first optical fiber defining a first input and a first output, and the second optical fiber defining a second input and a second output, comprising:
forming a biconical taper by fusing portions of the first and second optical fibers together and, then, stretching said fused optical fiber portions;
doping the first and second optical fibers with atoms at least in the biconical taper;
injecting the optical signal in the first input; and
injecting a pump light beam in the second input in order to control a propagation characteristic of the optical signal from the first input to the first and second ouputs through the biconical taper.

10. A propagation controlling method according to claim 9, wherein said pump light beam injection comprises:
selecting a wavelength of the pump light beam suitable for transferring energy from the pump light beam to the doping atoms.

11. A propagation controlling method according to claim 10, wherein said pump light beam injection also comprises:
adjusting an intensity of the pump light beam for controlling the propagation characteristic of the optical signal from the first input to the first and second ouputs through the biconical taper.

12. A propagation controlling method according to claim 10, wherein the doping atoms are Erbium atoms, and wherein the pump light beam is a 980-nm light beam.

13. A propagation controlling method according to claim 9, comprising forming another biconical taper by fusing together portions of the first and second optical fibers and, then, stretching the fused optical fiber portions, concatenating the two biconical tapers between (a) said first and second inputs and (b) said first and second outputs, and separating said two biconical tapers by sections of said first and second optical fibers to form a Mach-Zehnder fiber interferometer structure.

14. A propagation controlling method according to claim 13, comprising doping with said atoms the two biconical tapers and said sections of first and second optical fibers separating the two biconical tapers.

15. A propagation controlling method according to claim 13, comprising forming with said Mach-Zehnder fiber interferometer structure a comb-filter having a filtering characteristic dependent on the intensity of the pump light beam.

16. A propagation controlling method according to claim 9, wherein said optical signal comprises a plurality of multiplexed optical signals of different wavelengths, and wherein said propagation controlling method comprises adjusting the intensity of the pump light beam so as to propagate each optical signal toward a respective one of said first and second outputs.

What is claimed is:

1. An optical wavelength switch/filter device for controlling propagation of an optical signal, comprising:
first and second optical fibers;
a biconical taper formed of fused and stretched portions of the first and second optical fibers; and
doping atoms in at least the biconical taper of the first and second optical fibers; wherein:
said first optical fiber defines, on a first side of the biconical taper, a first optical signal input for being supplied with the optical signal;
said first and second optical fibers define, on a second side of the biconical taper opposite to said first side, first and second outputs, respectively; and
the second optical fiber defines, on said first side of the biconical taper, a second pump light beam input for being supplied with a pump light beam in order to control a propagation characteristic of the optical signal from the first input to the first and second ouputs through the biconical taper.

2. The optical wavelength switch/filter device of claim 1, further comprising a source of pump light beam connected to the second input to inject in said second input said pump light beam having:
a frequency selected to transfer energy from the pump light beam to the doping atoms; and
an intensity adjusted to obtain said propagation characteristic.

3. The optical wavelength switch/filter device of claim 2, wherein said source is a variable pump light beam source through which the intensity of the pump light beam is changed in order to modify the propagation characteristic of the optical signal from the first input to the first and second ouputs through the biconical taper.

4. The optical wavelength switch/filter device of claim 2, wherein the doping atoms are Erbium atoms, and wherein the pump light beam is a 980-nm light beam.

5. The optical wavelength switch/filter device of claim 1, further comprising another biconical taper formed of fused and stretched portions of the first and second optical fibers, the two biconical tapers being concatenated between (a) said first and second inputs and (b) said first and second outputs, and said two biconical tapers being separated by sections of said first and second optical fibers to form a Mach-Zehnder fiber interferometer structure.

6. The optical wavelength switch/filter device of claim 5, wherein the two biconical tapers and said sections of first and second optical fibers separating the two biconical tapers are doped with said atoms.

7. The optical wavelength switch/filter device of claim 5, wherein the Mach-Zehnder fiber interferometer structure forms a comb-filter having a wavelength characteristic dependent on the intensity of the pump light beam.

8. The optical wavelength switch/filter device of claim 3, wherein said optical signal comprises a plurality of multiplexed optical signals of different wavelengths, and wherein said source comprises means for adjusting the intensity of the pump light beam so as to propagate each optical signal toward a respective one of said first and second outputs.

9. A method for controlling propagation of an optical signal through first and second optical fibers, the first optical fiber defining a first input and a first output, and the second optical fiber defining a second input and a second output, comprising:
forming a biconical taper by fusing portions of the first and second optical fibers together and, then, stretching said fused optical fiber portions;
doping the first and second optical fibers with atoms at least in the biconical taper;
injecting the optical signal in the first input; and
injecting a pump light beam in the second input in order to control a propagation characteristic of the optical signal from the first input to the first and second ouputs through the biconical taper.

10. A propagation controlling method according to claim 9, wherein said pump light beam injection comprises:
selecting a wavelength of the pump light beam suitable for transferring energy from the pump light beam to the doping atoms.

11. A propagation controlling method according to claim 10, wherein said pump light beam injection also comprises:
adjusting an intensity of the pump light beam for controlling the propagation characteristic of the optical signal from the first input to the first and second ouputs through the biconical taper.

12. A propagation controlling method according to claim 10, wherein the doping atoms are Erbium atoms, and wherein the pump light beam is a 980-nm light beam.

13. A propagation controlling method according to claim 9, comprising forming another biconical taper by fusing together portions of the first and second optical fibers and, then, stretching the fused optical fiber portions, concatenating the two biconical tapers between (a) said first and second inputs and (b) said first and second outputs, and separating said two biconical tapers by sections of said first and second optical fibers to form a Mach-Zehnder fiber interferometer structure.

14. A propagation controlling method according to claim 13, comprising doping with said atoms the two biconical tapers and said sections of first and second optical fibers separating the two biconical tapers.

15. A propagation controlling method according to claim 13, comprising forming with said Mach-Zehnder fiber interferometer structure a comb-filter having a filtering characteristic dependent on the intensity of the pump light beam.

16. A propagation controlling method according to claim 9, wherein said optical signal comprises a plurality of multiplexed optical signals of different wavelengths, and wherein said propagation controlling method comprises adjusting the intensity of the pump light beam so as to propagate each optical signal toward a respective one of said first and second outputs.
